(19) United States
(12) Patent Application Publication
(10) Pub. No.: US 2026/0211700 A1
(43) Pub. Date: Jul. 23, 2026

(54) MANAGEMENT SYSTEM AS SECURE ENGINE TO MANAGE USER PRESENCE DETECT FEATURES

(71) Applicant: DELL PRODUCTS L.P., Round Rock, TX (US)

(72) Inventors: Yung-Sheng Lin, Taoyuan City (TW); Shun-Tang Hsu, Taipei (TW); Daniel L. Hamlin, Round Rock, TX (US)

(21) Appl. No.: 19/034,272

(22) Filed: Jan. 22, 2025

(51) Int. Cl. G06F 9/445

(52) U.S. Cl. CPC G06F 9/44505

(57) ABSTRACT

An information handling system includes sensor hardware, a configuration manager, a BMC, and an OEM sensor framework. The configuration manager provides an interface whereby configuration options for the information handling system are selected, including a platform type option specifying the information handling system as operating as one of a plurality of platform types. The BMC receives the selected configuration options from the configuration manager. The OEM sensor framework includes framework hardware and framework firmware from an OEM. The OEM sensor framework receives the selected configuration options and the platform type option, selects a set of sensor features from a plurality of sensor features to enable based on the selected configuration options and the platform type option, and enables a set of the sensor hardware based on the set of sensor features.

### FIELD OF THE DISCLOSURE

This disclosure relates to information handling systems, and more particularly relates to the use of a management system as a secure engine to manage user presence detect features in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include sensor hardware, a configuration manager, a BMC, and an OEM sensor framework. The configuration manager may provide an interface whereby configuration options for the information handling system are selected, including a platform type option specifying the information handling system as operating as one platform type. The BMC may receive the selected configuration options from the configuration manager. The OEM sensor framework may include framework hardware and framework firmware from an OEM. The OEM sensor framework may receive the selected configuration options and the platform type option, select a set of sensor features to enable based on the selected configuration options and the platform type option, and enable a set of the sensor hardware based on the set of sensor features.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates an information handling system according to an embodiment of the present disclosure;

FIG. 2 is a flow chart showing a method for using a management system as a secure engine to manage user presence detect features in an information handling system according to an embodiment of the present disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

Information handling systems may typically include user presence detect (UPD) functions and features that operate to detect the presence of a user in the vicinity of the information handling system. UPD functions and features may further be utilized to detect the presence of a particular user, vis-à-vis a different user, such as by facial recognition, behavior recognition, or the like. Manufacturers of information handling systems typically provide information handling systems based upon multiple original equipment manufacturer (OEM) hardware and firmware solutions. For example, the manufacturer may utilize one of several different OEM hardware and firmware solutions to manufacture multiple stock keeping units (SKUs) of similar information handling systems, or may utilize one of several different SKUs from a common OEM to manufacture multiple SKUs of information handling systems with different capabilities and at different price points. In designing information handling systems based upon multiple OEM hardware and firmware solutions, the manufacturer typically designs custom firmware for each SKU of their information handling systems. This results in long design cycle times and high design costs to maintain large product lines.

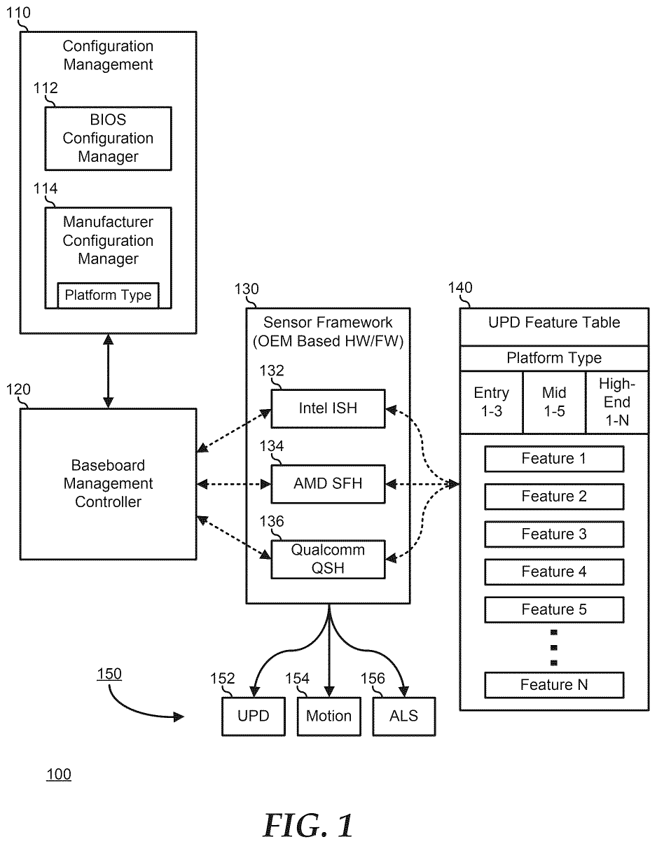

FIG. 1 illustrates an information handling system 100 including configuration management tools 110, a baseboard management controller (BMC) 120, a sensor framework 130, a user presence detect (UPD) feature table 140, and presence detectors 150. Configuration management tools 110 represent various interfaces, such as a graphical user interface (GUI), an application programming interface (API), or the like, that permit the selection of various functional options and features that are available on information handling system 100, as needed or desired. Configuration management tools 110 include a Basic Input/Output System (BIOS) configuration manager 112, and a manufacturer configuration manager 114. BIOS configuration manager 112 represents a user interface, typically presented as a GUI, that permits the user of information handling system 100 to select from among the various BIOS-based functional options and features, as needed or desired. Such BIOS-based functions and features typically include power management settings, boot operational settings, device-based settings (for example CPU settings, memory settings, storage settings, and the like), or other settings as needed or desired. As used herein, such BIOS-based functions and features will be described in the context of UPD settings, such as ambient light sensor (ALS) settings, motion-based sensor settings, image-based or behavior-based sensor settings, or the like.

Manufacturer configuration manager 114 represents an interface, typically presented as an API, whereby a manufacturer of information handling system 100 selects from among the various functional options and features, as needed or desired. Such functional options and features may include any or all of the BIOS-based functional options and features, as described above. In addition, various manufacturer-accessible functional options and features are managed via manufacturer configuration manager 114. For example, a manufacturer may include various value-add features that are enabled at a premium price point. For example, a common information handling system may be sold at a lower price point and may have some available functions and features disabled, while the same information handling system may be sold at a higher price point and may have a richer set of the functions and features enabled.

BMC 120 represents management hardware of information handling system 100 that operates out-of-band from a hosted environment instantiated on host hardware of the information handling system. BMC 120 provides for the monitoring, management, and maintenance of the hardware, functions, and features of information handling system 100. The selected functional options and features selected by configuration management tools 110 are provided to BMC 120. Some set of the selected functional options and features may be implemented directly from configuration management tools 110. The selections made can be provided to BMC 120 for informational purposes, or may be utilized by the BMC to implement other policies based upon the selection information, as needed or desired. In another case, some other set of the selected functional options and features may be implemented directly by BMC 120, as needed or desired.

Sensor framework 130 represents the various hardware configurations that are available to the manufacturer for use in designing and manufacturing an information handling system. In particular, sensor framework 130 represents a particular OEM's hardware and firmware that can be utilized to design and manufacture information handling systems. Thus, as illustrated, sensor framework 130 includes an Intel-based sensor framework, an AMD-based sensor framework, and a Qualcomm-based sensor framework. In particular, sensor framework 130 includes an Intel Integrated Sensor Hub (ISH) 132, an AMD Sensor Fusion Hub (SFH) 134, and a Qualcomm Sensor Hub (QSH) 136. Here, information handling system 100 will be understood to be designed and manufactured around only one (1) of the sensor frameworks (Intel ISH 132, AMD SFH 134, and Qualcomm QSH 136). Other OEM hardware and firmware may be utilized, as needed or desired.

UPD feature table 140 represents information established by the manufacturer of information handling system 100 that provides a correlation between the UPD functionality and features available on the information handling system with the various feature levels provided by the manufacturer for the particular price points of the information handling system. As such, UPD function table 140 includes entries for the various UPD features (Features 1-N), and a feature set listing associated with each feature level (entry, mid, and high-end). An entry-level system is ascribed to operate a limited group of features (Features 1-3), a mid-level system is ascribed to operate a less limited group of features (Features 1-5), and a high-end system is ascribed to operate as a fully featured system (Features 1-N). For example, a manufacturer may provide information handling system 100 at a low price point, for example, for a point-of-sale (POS) system, and may thus enable only motion-based features. On the other hand, the manufacturer may provide information handling system 100 at a mid-range price point, for example, for an information kiosk, and may thus enable ambient light detection features in addition to the motion-based features. Finally the manufacturer may provide information handling system 100 at a high-end price point, for example, for a personal computer system, and may thus enable image validation features in addition to the ambient light detection and motion-based features.

The features (Features 1-N) of UPD feature table 140 may represent generic UPD features, such as a detect motion feature, a detect ambient light level feature, a facial recognition feature, or the like. Thus it may be understood that each of Intel ISH 132, AMD SFH 134, and Qualcomm QSH 136 each include particular functions that are ascribed to the generic UPD features. In this case, the feature mappings for entry-level, mid-level, and high-end systems will be understood to map directly to the functions of the associated framework. Such mappings may be on a one-to-one basis, the functions of the associated framework may map to more than one feature, or more than one function may invoke multiple features, as needed or desired. In another case, the features (Features 1-N) of UPD feature table 140 represent vendor specific UPD features that can be mapped only to a particular one of Intel ISH 132, AMD SFH 134, or Qualcomm QSH 136.

Presence detectors 150 represents the hardware and firmware elements of information handling system that are utilized in determining whether or not a user is present in the vicinity of information handling system 100, and includes UPD detectors 152, motion detectors 154, and ALS detectors 156. Presence detectors 150 may include other hardware or firmware, as needed or desired, such as fingerprint detectors, facial recognition features, sound detectors, or the like. Intel ISH 132, AMD SFH 134, and Qualcomm QSH 136 each operate to utilize the mappings form UPD feature table 140 to implement the specific operating states of presence detectors 150 based upon the functions associated with the type of system (i.e., entry-level, mid-level, or high-end).

Based upon the functionality of information handling system 100 as described above, the manufacturer of the information handling system need only to design one management environment, with a common management environment firmware, in order to accommodate multiple sensor frameworks and multiple system types for UPD functionality, in contrast to the need for multiple iterations of the management environment firmware for a typical manufacturer's product line, as described above.

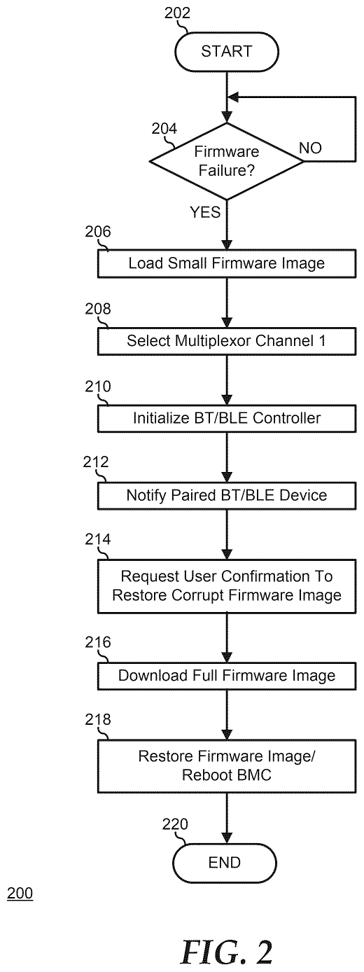

FIG. 2 illustrates a method 200 for the use of a management system as a secure engine to manage user presence detect features in an information handling system, starting at block 202. Configuration options are selected for the UPD features of an information handling system in block 204. The configuration options may be selected via a BIOS configuration manager or a manufacturer configuration manager, as needed or desired. A BMC of the information handling system receives the selected feature options from the configuration managers in block 204. In a particular case, the selected feature options as securely transferred from the configuration managers to the BMC in block 206. Such a secure transfer may be over a secure link in the information handling system, or by encoding/decoding the feature options, as needed or desired.

The list of selected features are forwarded by the BMC to the sensor framework in block 208. The sensor framework determines the system type and obtains a system-based feature list from a UPD feature set table in block 210. The sensor framework may determine the system type from the BMC, from a configuration setting, such as may be set by the manufacturer configuration manager, or the like. The sensor framework initializes the presence detectors of the information handling system based on the feature set associated with the system type in block 212. Finally, the sensor framework notifies the BMC of the enabled features in block 214, and the method ends in block 216.

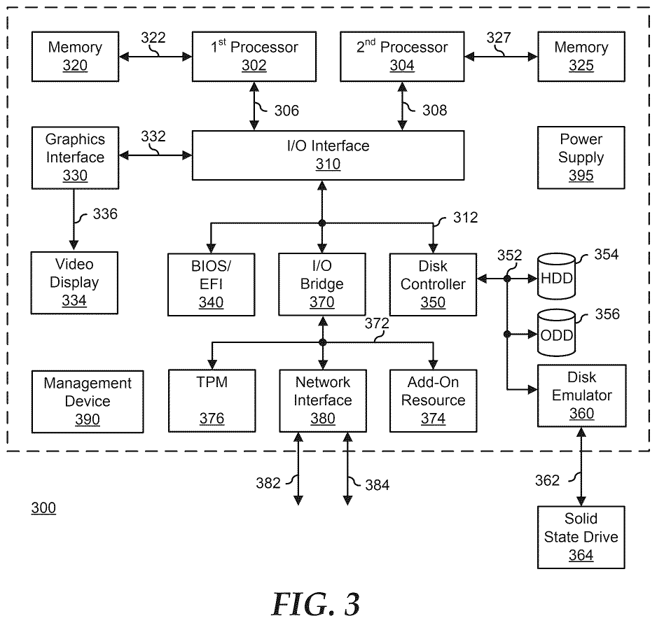

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
sensor hardware;
a configuration manager operable to provide an interface whereby configuration options for the information handling system are selected, the configuration options including a platform type option specifying the information handling system as operating as one of a plurality of platform types;
a baseboard management controller (BMC) configured to receive the selected configuration options from the configuration manager; and
an original equipment manufacturer (OEM) sensor framework including framework hardware and framework firmware from an OEM, the OEM sensor framework configured to receive the selected configuration options and the platform type option, to select a set of sensor features from a plurality of sensor features to enable based on the selected configuration options and the platform type option, and to enable a set of the sensor hardware based on the set of sensor features.

2. The information handling system of claim 1, wherein the configuration manager includes a basic input/output system (BIOS) configuration manager and a manufacturer configuration manager.

3. The information handling system of claim 2, wherein the platform type option is set by the manufacturer configuration manager.

4. The information handling system of claim 1, wherein the configuration manager encodes the selected configuration options prior to sending the configuration options to the BMC.

5. The information handling system of claim 1, wherein, when the platform type option indicates that the information handling system is operating as a first platform type, the set of sensor features includes a first subset of the sensor features.

6. The information handling system of claim 5, wherein when the platform type option indicates that the information handling system is operating as a second platform type, the set of sensor features includes the first subset and a second subset of the sensor features.

7. The information handling system of claim 6, wherein when the platform type option indicates that the information handling system is operating as a third platform type, the set of sensor features includes the plurality of sensor features.

8. The information handling system of claim 1, wherein the sensor hardware includes a motion detector.

9. The information handling system of claim 1, wherein the sensor hardware includes an ambient light sensor.

10. The information handling system of claim 1, wherein the sensor hardware includes a user presence detector.

11. A method, comprising:
providing, in an information handling system, sensor hardware;
providing, in the information handling system, a configuration manager operable to provide an interface whereby configuration options for the information handling system are selected, the configuration options including a platform type option specifying the information handling system as operating as one of a plurality of platform types;
providing, in the information handling system, a baseboard management controller (BMC) configured to receive the selected configuration options from the configuration manager;
providing, in the information handling system, an original equipment manufacturer (OEM) sensor framework including framework hardware and framework firmware from an OEM;
receiving, by the OEM sensor framework, the selected configuration options and the platform type option;
selecting, by the OEM sensor framework, select a set of sensor features from a plurality of sensor features to enable based on the selected configuration options and the platform type option; and
enabling, by the OEM sensor framework, a set of the sensor hardware based on the set of sensor features.

12. The method of claim 11, wherein the configuration manager includes a basic input/output system (BIOS) configuration manager and a manufacturer configuration manager.

13. The method of claim 12, wherein the platform type option is set by the manufacturer configuration manager.

14. The method of claim 11, further comprising encoding, by the configuration manager, the selected configuration options prior to sending the configuration options to the BMC.

15. The method of claim 11, wherein when the platform type option indicates that the information handling system is operating as a first platform type, the set of sensor features includes a first subset of the sensor features.

16. The method of claim 15, wherein, when the platform type option indicates that the information handling system is operating as a second platform type, the set of sensor features includes the first subset and a second subset of the sensor features.

17. The method of claim 16, wherein, when the platform type option indicates that the information handling system is operating as a third platform type, the set of sensor features includes the plurality of sensor features.

18. The method of claim 11, wherein the sensor hardware includes a motion detector.

19. The method of claim 11, wherein the sensor hardware includes an ambient light sensor.

20. An information handling system, comprising:
sensor hardware that includes a motion detector, an ambient light sensor, and a user presence detector;
a configuration manager operable to provide an interface whereby configuration options for the information handling system are selected, the configuration options including a platform type option specifying the information handling system as operating as one of a plurality of platform types;
a baseboard management controller configured to receive the selected configuration options from the configuration manager; and
an original equipment manufacturer (OEM) sensor framework including framework hardware and framework firmware from a first OEM, the OEM sensor framework configured to receive the selected configuration options and the platform type option, to select a set of sensor features from a plurality of sensor features to enable based on the selected configuration options and the platform type option, and to enable a set of the sensor hardware based on the set of sensor features.
